(19) United States
(12) Patent Application Publication
(10) Pub. No.: US 2012/0167667 A1
(43) Pub. Date: Jul. 5, 2012

(54) GLOVE TESTING DEVICE AND METHOD

(76) Inventor: Randall L. Shipley, Sherwood, OR (US)

(21) Appl. No.: 13/286,687

(22) Filed: Nov. 1, 2011

Related U.S. Application Data
(60) Provisional application No. 61/409,892, filed on Nov. 3, 2010.

(51) Int. Cl. G01M 3/04

(52) U.S. Cl. 73/40

(57) ABSTRACT

The present invention relates to a glove testing device and method for air testing of gloves particularly of the insulative type used by linemen and electricians. The device may be moved relative to the lengthwise direction of the glove to successively seal shut securely each portion of the glove passed by the device so that air trapped in the glove progressively inflates the glove. In particular, the glove may be rolled about the testing or spool device starting adjacent the glove's open mouth either by rotating the device or wrapping the glove or by a combination of these movements. The device may include cantilevered arms forming a lateral gap for lateral insertion of the glove's end portion and may have rounded outer surfaces that avoid placing sharp folds in the glove during the rolling operation.

### CROSS-REFERENCE TO RELATED APPLICATIONS

This application claims the benefit of U.S. Provisional App. No. 61/409,892, filed Nov. 3, 2010.

### BACKGROUND OF THE INVENTION

The present invention relates to testing the physical integrity of gloves. In particular, the invention relates to testing the integrity of gloves by air inflation to identify any cut, abrasion, or puncture in the glove.

Gloves used by electrical workers or linemen for protection against high voltages are made of an insulative material such as natural or synthetic rubber. It is highly critical that such gloves be properly inspected to ensure they are completely free of defects. Failure to exercise this precaution can have severe consequences including worker electrocution and death.

Defects may result in electrical gloves from a variety of causes including improper folding (the strain on rubber at a folded point is equal to stretching the glove to twice its length), pinpoint puncture by wires or metal shavings, chemical attack by oil or petroleum compounds, rope or cable burns, and ozone cutting. For such reasons, the American Society for Testing and Materials has promulgated a standard, ASTM F496, for field testing insulative gloves of the type used by electrical workers. This standard recommends, among other things, that such gloves be tested before every use by being filled with air and then inspected, by listening or feeling, to detect any escaping air. This procedure also more than satisfies federal requirements (see OSHA 1910.137(b)(2)(ix)) which require, at a minimum, air testing of insulative gloves once-a-day or after any incident reasonably suspected of causing glove damage (see OSHA 1910.137(b)(2)(ii)). Federal requirements also require electrical testing of the gloves at intervals not exceeding six months; however this more elaborate procedure, also called dielectric testing, typically involves high voltages and conductive chemical baths and is seldom employed by workers in the field.

One way to field test electrical gloves is to hold the rolled cuff with one hand so that air is trapped inside and then to apply pressure with the other hand to different areas of the glove while listening for escaping air. With this approach, however, the air tends to escape back out the rolled cuff so that certain portions of the glove, such as the fingers, are not sufficiently inflated and small defects may go undetected. Alternatively, the cuff may be grasped by one hand and twisted lengthwise along the wristband. While sufficient air may then be forced into the thumb and fingers using the other hand, here defects along the wristband portion may go undetected. Moreover, the glove material may be easily damaged by improper rolling or twisting of the glove.

To improve test reliability, various glove testing apparatus have been developed. For example, U.S. Pat. No. 7,143,633 to Westerberg shows an apparatus having a hollow housing forming, at one end, a stacked series of round grooves. The glove's cuff is stretched over a suitably sized one of the grooves and then held in place by a stretchable O-ring, band, or strip. An inflator or bellows, placed at the other end of the housing, is pumped in order to inflate the glove for inspection. However the elastic O-ring or strip may break while being stretched to fit over the cuff so as to render the apparatus inoperable. Moreover, the apparatus uses a removable one-way value to prevent airflow back out the glove during inflation, and both this valve and the O-ring may be easily misplaced. Until replacement parts can be found, the lineman is forced to fall back to a manual method as described above. Also, with its multiple elements, the Westerberg apparatus is relatively expensive to make, so that providing the apparatus for every lineman in the field is costly.

An alternative testing apparatus is shown in U.S. Pat. No. 3,603,138 to Peterson. Here the cuff of the glove is inserted into a round channel of U-shaped cross section. A flexible liner arranged along the inner channel surface is pneumatically driven to force the cuff against the outer channel surface, whereupon the glove can be inflated by the same pressurized air source used to drive the liner. A similar concept is shown in French Pat. Publication 2,643,713 which uses an inner inflatable bladder to force the cuff outwardly to engage a holding means. These apparatus are subject to breakdown, such as if the liner or bladder develop a leak, are relatively expensive to make, and require extensive training in order to use properly.

Other systems for mounting the glove for inflation include spring-loaded jaws, such as shown in U.S. Pat. No. 2,370,945 to Fields, a channel for receiving the beaded edge of the cuff as shown in U.S. Pat. No. 2,074,140 to Bates, a rib for holding the inner wrist portion of the glove by pressure fit as shown in U.S. Pat. No. 2,543,911 to Isaacs, and an elastomeric O-ring that is squeezed between two jaws to expand against the inner cuff portion and so force the cuff portion to engage an outer rim or collar as shown in French Pat. Publication 2,530,813. These systems are either complex to build or fail to secure the glove sufficiently to permit adequate glove inflation.

U.S. Pat. No. 3,820,383 to Van Deventer et al. goes so far as to suggest that the general procedure of inflating the glove and then immediately holding the glove “close to [the] face” to sense leaks is ineffective in detecting small defects and that a better approach is to let the inflated gloves travel on an automatic conveyor “preferably about 15 minutes” so that “leakers” become readily apparent to the naked eye. In Van Deventer, the press fit used to hold the glove's cuff over the lip on the inflating mount may not be sufficient to permit adequate glove inflation. In any event, Van Deventer's approach is clearly not practical either from the standpoint of time or cost for linemen in the field.

### BRIEF SUMMARY OF THE INVENTION

In one aspect in accordance with the present invention, a glove is tested by rolling the glove about a spool device starting adjacent the glove's open mouth so as to inflate the glove for inspection. The glove is inflated securely as it is wound about the spool device so as to allow the glove to be adequately inflated for reliable testing. Furthermore, the spool device may be of inexpensive design lacking, for example, multiple parts that might break or require expensive assembly. Thus every lineman may be outfitted with the device, the device may be easily operated without extensive time or training, and the high safety risks that accompany purely manual testing may be avoided.

In a second aspect, an end portion of a glove adjacent the glove's open mouth is received between an opposed pair of elongate holding surfaces formed by a glove testing device and the glove testing device is moved relative to the lengthwise direction of the glove so as to successively seal shut each portion of the glove passed by the device so that air trapped in the glove progressively inflates the glove. This allows a maximum portion of the glove to be properly tested, that is, the lengthwise movement of the testing device relative to the glove may be stopped at any point where the glove is adequately inflated. This avoids, at the same time, overinflation of the glove so as to prevent damage to the glove material.

In a third aspect, the spool or testing device is configured to be moved relative to the glove so as to avoid placing sharp folds in the glove. This prevents damage to the glove caused by the device itself due to overstretching of the glove material. In particular, the device may provide rounded outer surfaces about which the glove may be rolled.

In a fourth aspect, the spool or testing device includes elongate arms and the elongate arms extend in cantilevered arrangement. These cantilevered arms form a lateral gap into which the end portion of the glove may be laterally inserted. Not only does this avoid having to thread the glove's mouth into a narrow channel or to fit the bead of the mouth one circumferential section at a time onto a groove, but these arms can easily receive gloves that have mouths of varying width. Moreover, a certain amount of play is desirably provided by the cantilevered arms so that gloves of varying thickness may be easily accommodated. Preferably, the entire device is molded in one-piece of low-cost material so that the device may be inexpensively purchased and conveniently transported to encourage widespread use in the field.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a side elevational view of a preferred embodiment of the glove tester constructed in accordance with the present invention.

FIG. 2 is a top elevational view of the glove tester of FIG. 1 respectively showing, in solid- and dashed-line view, how the tester receives the end portion of a glove to be tested despite variance in the glove width.

FIG. 3 is a top elevational view of the glove tester of FIG. 1 showing the glove tester of FIG. 1 after a glove has preferably been rolled about the tester to inflate the glove in accordance with the present invention.

FIGS. 4a and 4b are sectional views taken along lines 4a-4a in FIGS. 1 and 4b-4b in FIG. 2, respectively.

FIG. 4c is a sectional view corresponding to FIG. 4b but taken after the glove has been rolled about the glove tester in accordance with the present invention.

### DETAILED DESCRIPTION OF PREFERRED EMBODIMENT

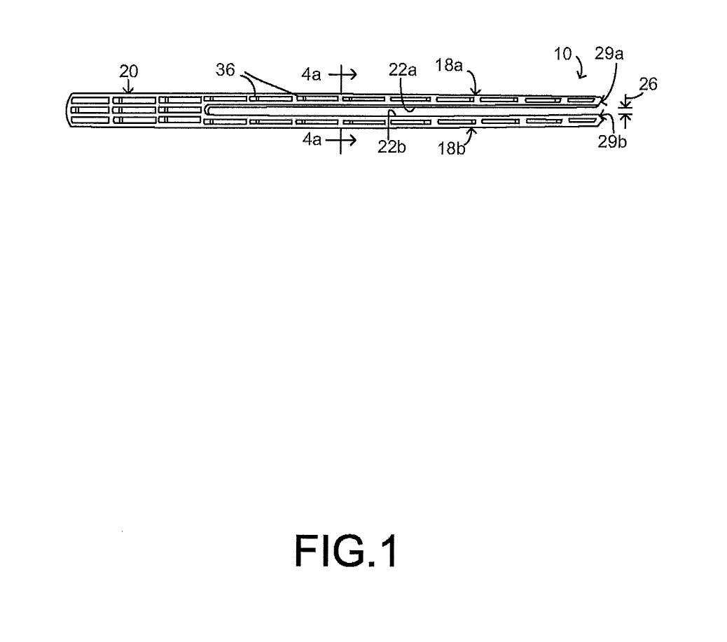

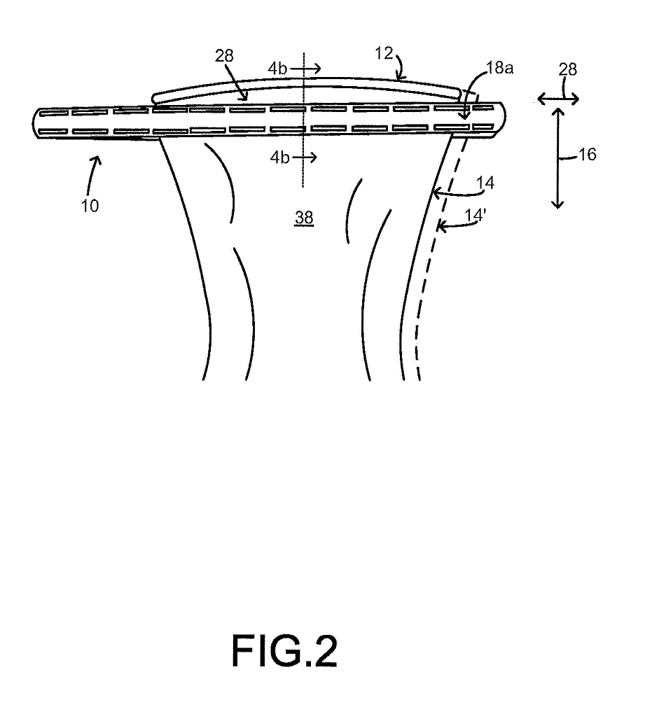

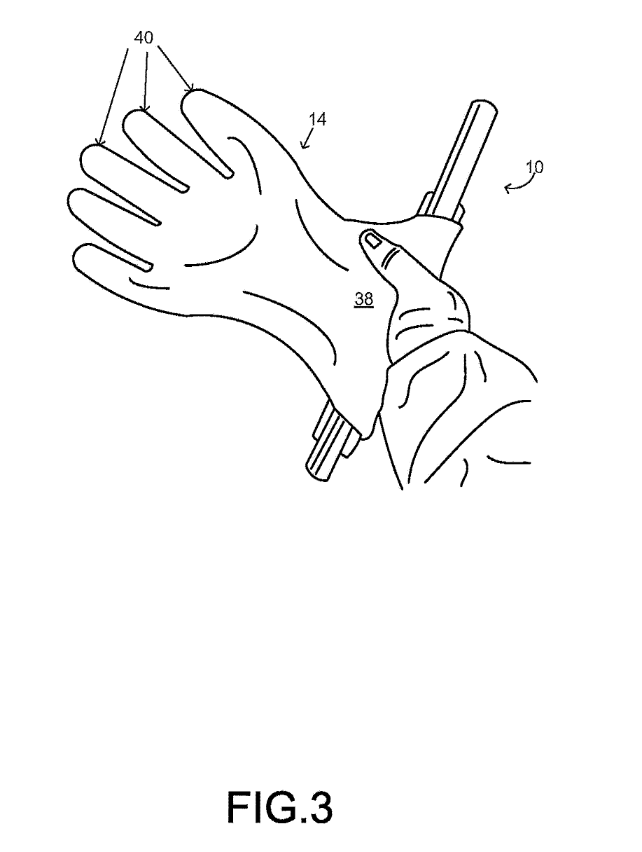

FIG. 1 shows an exemplary glove testing or spool device 10 constructed in accordance with the present invention. Referring to FIG. 2, the device is configured to receive the open mouth 12 of an insulative glove 14, particularly a natural or synthetic rubber glove of the type used by linemen or electricians to guard against electrical shock. As discussed further below, the device is configured to be moved relative to the lengthwise direction 16 of the glove so as to successively seal shut each portion of the glove passed by the device. Here and in the claims, the phrase “moved relative to” is merely intended to indicate relative movement so as to cover movement by the device alone, the glove alone, or both the device and glove together. As each portion of the glove passed by the device is sealed shut, the air trapped in the glove progressively inflates the glove. In particular, starting adjacent the open mouth, the glove is preferably rolled about the spool device 10 so as to inflate the glove for inspection, as indicated in FIG. 3. It will be recognized that this rolling operation securely seals shut each portion of the glove passed by the device, that is, there is little likelihood of the trapped air escaping through the glove's wound portion back out the open mouth as inflation progresses. This, in turn, ensures that the entire glove may be adequately inflated for reliable testing to occur. In other words, the glove is inflated sufficiently, even in the extreme finger portions, that any leakage of air from the glove caused by a pinpoint hole or other defect will result in an outgoing stream of air that is sufficiently strong for the lineman to easily feel or hear it by holding, for example, the inflated glove near the cheek or ear, respectively.

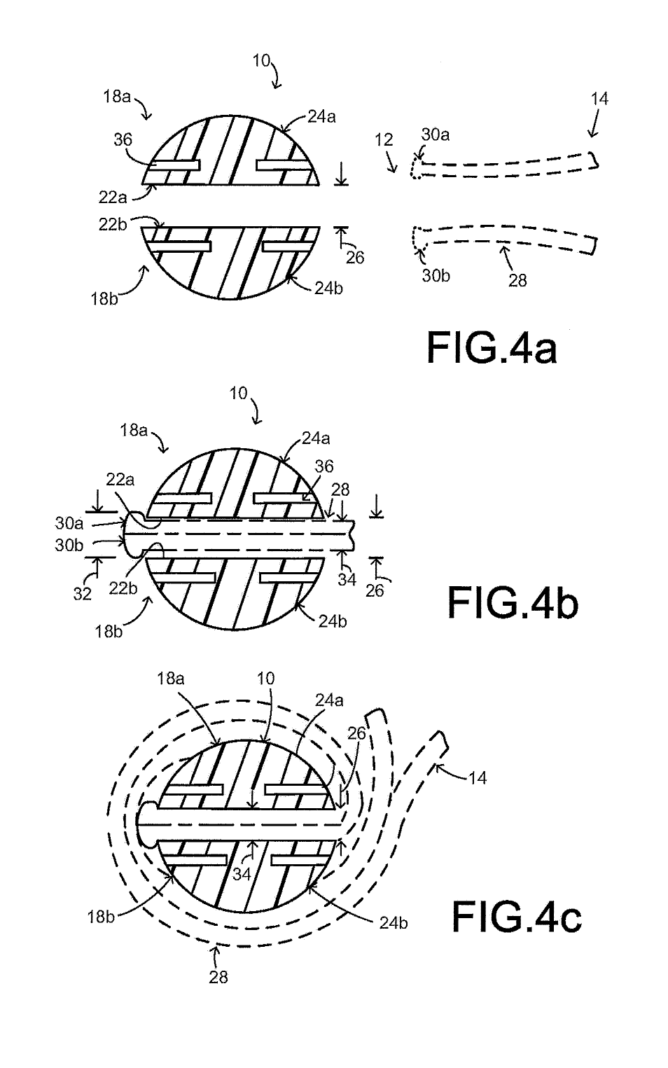

Referring to FIG. 1, the exemplary testing or spool device 10 has an opposed pair of elongate arms 18a and 18b that extend in cantilevered arrangement from a base or handle portion 20. Referring to FIG. 4a, each elongate arm 18a, 18b forms a generally flat holding surface 22a, 22b and a rounded outer surface 24a, 24b, respectively. Referring also to FIG. 2, the elongate arms together define a lateral gap 26 into which an end portion 28 of the glove may be inserted, that is the end portion may be inserted between the opposed pair of elongate holding surfaces 22a, 22b in a direction 28 generally lateral to the glove's open mouth 12. Inwardly tapered edges 29a, 29b (FIG. 1) on the arms 18a, 18b serve to guide and facilitate this insertion. This avoids having to thread the entire mouth all at one time into a narrow channel, that is, once a side margin of the end portion 28 is introduced into the gap, the remainder of the end portion is easily pulled into the channel. Furthermore, the cantilevered arm arrangement easily accommodates gloves of varying width. As indicated in dashed line view in FIG. 2, preferably the length of the elongate holding surfaces is made sufficiently long to grip a glove 14′ of the maximum width contemplated for use with the device.

The cantilevered arm arrangement, moreover, easily accommodates gloves of varying thickness. For example, referring to FIGS. 4a and 4b together, the end portion 28 of the glove may be inserted laterally into the gap 26 even if the beads 30a, 30b that reinforce the glove's open mouth 12 have a combined thickness 32 that exceeds the gap's thickness. Likewise, referring to FIGS. 4b and 4c together, if the thickness 34 of the glove's end portion is smaller than the gap 26, the elongate arms 18a, 18b may be pinched together at their suspended ends to temporarily narrow the gap and grip the end portion so that rolling of the glove may immediately begin without the inconvenience of initial slippage. Conversely, the arms may be spread apart at their suspended ends to accommodate a glove having an end portion slightly thicker than the gap. In the preferred embodiment, the testing or spool device 10 is inexpensively molded in one-piece from plastic material, and the cantilevered arms 18a, 18b afford sufficient play to enable the operations just described. For enhanced durability, a series of longitudinally spaced ribs 36 are provided along each elongate arm.

As indicated in FIG. 4a, the elongate arms 18a, 18b of the spool device 10 form rounded outer surfaces 24a, 24b, respectively. Referring to FIGS. 4b and 4c, as the end portion 28 of the glove is rolled about the device, these rounded outer surfaces serve to coil the glove in such a manner as to automatically avoid placing a sharp fold in the glove. For example, as indicated in FIG. 4c, the maximum bend in the glove occurs where the glove exits the lateral gap 26 at about a 90 degree angle. At no time does the glove reverse back on itself in a substantially 180 degree turn as may easily occur, for example, if an attempt were made to manually roll the end portion on a flat table without the shape-holding function provided by the outer surfaces. In this manner, then, overstretching of the glove due to sharp folding is automatically prevented, and the glove may be safely rolled and inflated without risking damage to the glove during the process.

Referring to FIGS. 2 and 4c, as the glove 14 is moved in its lengthwise direction 16 relative to the testing device 10, for example, due to rotating movement of the device or wrapping movement of the glove, each portion of the glove passed by the device is securely sealed shut. There is little risk, in particular, of the air escaping past the wound end portion 28 back out the open mouth of the glove. The device, in other words, enables the lineman or other operator to precisely control the degree of inflation of the glove as a function of the amount of relative movement. For example, referring to FIG. 3, the operator may first move and inflate the glove sufficiently to adequately test the glove's forearm or wristband portion 38 and then, if desired, further move and inflate the glove sufficiently to adequately test the glove's extremities or finger portions 40. Movement and inflation of the glove beyond the point where adequate testing may be performed is easily avoided so there is little risk of overinflating and damaging the glove. If desired, the glove may also be turned inside-out and the inflation process repeated to ensure a thorough glove inspection.

From the foregoing description, it will be recognized that the testing or spool device 10 is particularly well suited for use by linemen and electricians in the field. It provides a safe and reliable inspection of an insulative glove, it may be manufactured and sold inexpensively enough for use by each individual, it is sufficiently lightweight and streamlined to be easily carried about, and it may be quickly and conveniently operated without a high degree of skill or training.

Although an exemplary embodiment of the testing or spool device 10 has been described, it will be recognized that variants of the device are possible without departing from at least the broader principles of one or more inventive aspects. For example, the device may be configured for rolling operation without offering the lateral gap or the holding surfaces may form a gap extending only partway through the device. These modifications, however, may make insertion of the glove's end portion into the device more difficult and different thicknesses of gloves may not be as readily accommodated. The device's base portion may be differently configured to include a thumb or hand grip, although this may cause increased material expense and make the device less convenient to carry about in a tight pocket. The outer surface of the arms of the device may be differently shaped, although desirably the arms are not of such flatness as to place sharp folds in the gloves. Other variants are possible and will be apparent to those of ordinary skill in the art.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method comprising rolling a glove about a spool device starting adjacent the glove's open mouth so as to inflate the glove for inspection.

2. The method of claim 1 including rolling the glove about the spool device in a manner that avoids placing a sharp fold in the glove.

3. The method of claim 2 including automatically avoiding reversing the glove back on itself in a substantially 180 degree turn.

4. The method of claim 1 including inserting an end portion of the glove adjacent the glove's open mouth between opposed holding surfaces formed by the spool device before rolling the glove.

5. The method of claim 4 including inserting the end portion of the glove between the opposed holding surfaces in a direction generally lateral to the glove's open mouth.

6. An apparatus comprising a spool device configured such that a glove may be rolled about the spool device starting adjacent the open mouth of the glove so as to inflate the glove for inspection.

7. The apparatus of claim 6 wherein the spool device is configured to enable the glove to be rolled about the spool device in a manner avoiding placing a sharp fold in the glove.

8. The apparatus of claim 7 wherein the device automatically avoids reversing the glove back on itself in a substantially 180 degree turn.

9. The apparatus of claim 6 wherein the spool device forms opposed holding surfaces through which an end portion of the glove adjacent the glove's open mouth may be inserted before rolling the glove.

10. The apparatus of claim 9 wherein the opposed holding surfaces are configured to receive the inserted end portion of the glove including in a direction generally lateral to the glove's open mouth.

11. A method comprising receiving an end portion of a glove adjacent the glove's open mouth between an opposed pair of elongate holding surfaces formed by a glove testing device and moving the glove testing device relative to the lengthwise direction of the glove so as to successively seal shut each portion of the glove passed by the device so that air trapped in the glove progressively inflates the glove.

12. The method of claim 11 including moving the glove testing device so as to avoid placing a sharp fold in the glove.

13. The method of claim 12 including automatically avoiding reversing the glove back on itself in a substantially 180 degree turn.

14. The method of claim 11 including moving the testing device relative to the lengthwise direction of the glove by rolling the glove about the testing device.

15. An apparatus comprising a glove testing device having an opposed pair of elongate holding surfaces for receiving therebetween an end portion of the glove adjacent the glove's open mouth, the device being configured to be moved relative to the lengthwise direction of the glove so as to successively seal shut each portion of the glove passed by the device so that air trapped in the glove progressively inflates the glove.

16. The apparatus of claim 15 wherein the glove testing device is configured to be moved so as to automatically avoid placing a sharp fold in the glove.

17. The apparatus of claim 16 wherein the opposed pair of elongate holding surfaces are formed by an opposed pair of elongate arms and each elongate arm has a rounded outer surface about which the glove may be rolled without placing a sharp fold in the glove.

18. The apparatus of claim 15 wherein the opposed pair of elongate holding surfaces are configured to receive the end portion of the glove by insertion of the end portion between the opposed pair of elongate holding surfaces in a direction generally lateral to the glove's open mouth.

19. The apparatus of claim 18 wherein the opposed pair of elongate holding surfaces are formed by an opposed pair of elongate arms and the elongate arms extend in cantilevered arrangement to form a lateral gap into which the end portion of the glove may be laterally inserted.

20. The apparatus of claim 15 wherein the glove testing device is configured to be moved relative to the lengthwise direction of the glove by rolling the glove about the glove testing device.
